(19) United States
(12) Patent Application Publication
(10) Pub. No.: US 2011/0090532 A1
(43) Pub. Date: Apr. 21, 2011

(54) IMAGE FORMING APPARATUS AND PROGRAM OPERATING METHOD

(75) Inventor: Hidehiko WATANABE, Kanagawa (JP)

(73) Assignee: RICOH COMPANY, LTD., Tokyo (JP)

(21) Appl. No.: 12/900,582

(22) Filed: Oct. 8, 2010

(30) Foreign Application Priority Data
Oct. 16, 2009 (JP) 2009-238978

(51) Int. Cl. G06F 3/12

(52) U.S. Cl. 358/1.15

(57) ABSTRACT

An image forming apparatus includes an acquisition part configured to cause a first screen for selecting a first program to be displayed on a display part, and to acquire the first program selected on the first screen from an external storage part, the first program being capable of having a process thereof dynamically interrupt a second program of the image forming apparatus; and an enablement part configured to apply the obtained first program to the second program.

### BACKGROUND OF THE INVENTION

1. Field of the Invention

The present invention relates generally to image forming apparatuses and program operating methods, and more particularly to an image forming apparatus implementing a function by the control of a program and a program operating method executed by the image forming apparatus.

2. Description of the Related Art

Conventionally, as a typical operation of the fault analysis (such as debugging) of a program operating in an embedded device in particular, the logs output by the program are analyzed. In the source code of the program, the values of variables used by the program and commands for outputting information indicating the state of hardware in which the program is operating (for example, printf [which stands for “print formatted”] functions in the C programming language) are embedded in advance in various parts. In the case of occurrence of a fault, the cause of the fault is inferred or identified by analyzing the log file output in accordance with such commands (hereinafter referred to as “log output commands”).

However, the log file output based on the pre-embedded log output commands (the first output log file) is often insufficient as information for detailed analysis. In such a case, the cause of the fault is narrowed down to some parts based on the first output log file. Then, the source code of the program is corrected so that more detailed logs are output with respect to the vicinities of the parts, and after compiling and linking, the program is replaced. If the cause of the fault cannot be identified even with a newly output log file, log output commands are embedded in the source code, and the above-described operation is repeated. Thus, in the case of making a fault analysis based on logs, there are occasions when a very complicated operation is required.

Therefore, conventionally, there is the technique of causing the process of another program (hereinafter referred to as “additional program”) to dynamically interrupt a program in operation (a diagnostic position) by (for example, Japanese Laid-Open Patent Application Nos. 2009-146387 and 2008-269163). In the additional program, it is possible to refer to the values of the variables of the program to be diagnosed. After completion of the process of the additional program, the process returns to the position at which the program to be diagnosed has been interrupted by the additional program. According to this technique, it is possible to output logs of the program to be diagnosed with the additional program without correcting the source code of the program to be diagnosed.

### SUMMARY OF THE INVENTION

According to one aspect of the present invention, an image forming apparatus includes an acquisition part configured to cause a first screen for selecting a first program to be displayed on a display part, and to acquire the first program selected on the first screen from an external storage part, the first program being capable of having a process thereof dynamically interrupt a second program of the image forming apparatus; and an enablement part configured to apply the obtained first program to the second program.

According to one aspect of the present invention, a program operating method executed by an image forming apparatus includes causing a first screen for selecting a first program to be displayed on a display part, the first program being capable of having a process thereof dynamically interrupt a second program of the image forming apparatus; acquiring the first program selected on the first screen from an external storage part; and applying the obtained first program to the second program.

The object and advantages of the invention will be realized and attained by means of the elements and combinations particularly pointed out in the claims.

It is to be understood that both the foregoing general description and the following detailed description are exemplary and explanatory and not restrictive of the invention as claimed.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram illustrating a hardware configuration of an image forming apparatus according to an embodiment of the present invention;

FIG. 2 is a block diagram illustrating a software configuration of the image forming apparatus according to the embodiment of the present invention;

FIG. 3 is a diagram for illustrating an additional program according to the embodiment of the present invention;

FIG. 4 is a block diagram illustrating a functional configuration of an additional program management application according to the embodiment of the present invention;

FIG. 5 is a diagram for illustrating the state transition of the additional program in the image forming apparatus according to the embodiment of the present invention;

FIG. 6 is a flowchart for illustrating an installation process of the additional program management application according to the embodiment of the present invention;

FIG. 7 is a diagram illustrating an application information file according to the embodiment of the present invention;

FIG. 8 is a sequence diagram for illustrating a procedure of the image forming apparatus that the additional program management application causes to be executed according to the embodiment of the present invention;

FIG. 9 is a diagram illustrating an example of the display of a logon screen according to the embodiment of the present invention;

FIG. 10 is a diagram illustrating an example of the display of a management screen according to the embodiment of the present invention;

FIG. 11 is a diagram illustrating a configuration of a state storage part according to the embodiment of the present invention; and

FIG. 12 is a diagram illustrating an example of the display of a download screen according to the embodiment of the present invention.

### DETAILED DESCRIPTION OF THE PREFERRED EMBODIMENTS

As described above, there is the conventional technique of causing a program in operation to be dynamically interrupted at a desired point by the process of an additional program. However, systems such as those described in Japanese Laid-Open Patent Application Nos. 2009-146387 and 2008-269163 require a management server. This is because an individual apparatus has only a passive function with respect to the operation of the additional program, so that an instruction needs to be given from the management server on the introduction of the additional program into the apparatus and the operation of the additional program introduced into the apparatus. It is believed that the management server is normally a personal computer (PC) of a user or a PC of a provider of the apparatus. In either case, the situation is not particularly favorable to the user.

That is, in the case where the management server is the user's PC, the user has to bear the cost of the PC used as the management server. On the other hand, when the management server is the apparatus provider's PC, the user feels uncomfortable in terms of security.

According to one aspect of the present invention, an image forming apparatus and a program operating method are capable of simplifying a system configuration for causing a program to be operated, the program being capable of causing a process to dynamically interrupt another program.

A description is given below, with reference to the accompanying drawings, of an embodiment of the present invention.

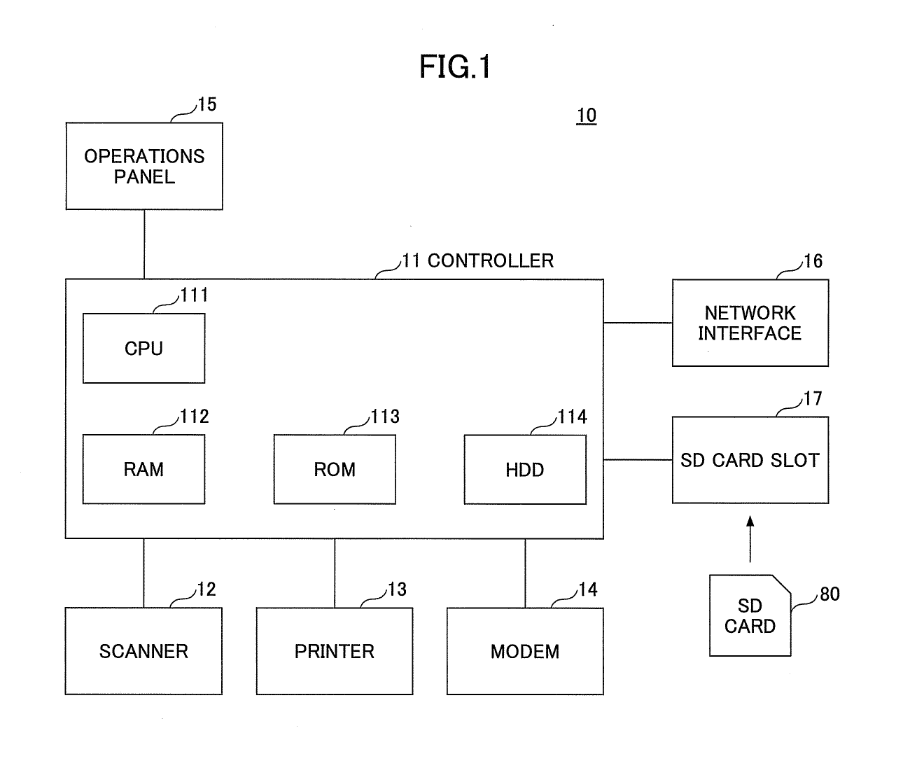

FIG. 1 is a block diagram illustrating a hardware configuration of an image forming apparatus according to the embodiment of the present invention.

Referring to FIG. 1, an image forming apparatus 10 includes hardware items such as a controller 11, a scanner 12, a printer 13, a modem 14, an operations panel 15, a network interface 16, and an SD card slot 17.

The controller 11 includes a central processing unit (CPU) 111, a random access memory (RAM) 112, a read-only memory (ROM) 113, and a hard disk drive (HDD) 114. Programs and data used by the programs are recorded in the ROM 113. The RAM 112 is used as a storage area for loading a program and a work area for the loaded program. The CPU 111 implements functions by executing programs loaded into the RAM 112. Programs and data used by the programs are recorded in the HDD 114.

The scanner 12 is a hardware item for reading image data from original material such as a document. The printer 13 is a hardware item for printing data on printing paper. The modem 14 is a hardware item for connecting to a telephone line, and is used for transmitting and receiving image data via facsimile (FAX) communications. The operations panel 15 is a hardware item that includes an input part such as buttons for receiving a user's input and a display part such as a liquid crystal panel. The network interface 16 is a hardware item for connecting to a network (which may be either wired or wireless) such as a local area network (LAN). The SD card slot 17 is used to read programs recorded in an SD card 80. That is, according to the image forming apparatus 10, not only the programs recorded in the ROM 113 but also the programs recorded in the SD card 80 may be loaded into the RAM 112 and executed. The SD card 80 may be replaced with another recording medium such as a CD-ROM or a USB (universal serial bus) memory. That is, the recording medium replacing the SD card 80 is not limited to certain types. In this case, the SD card slot 17 may be replaced with a hardware item according to the type of the recording medium.

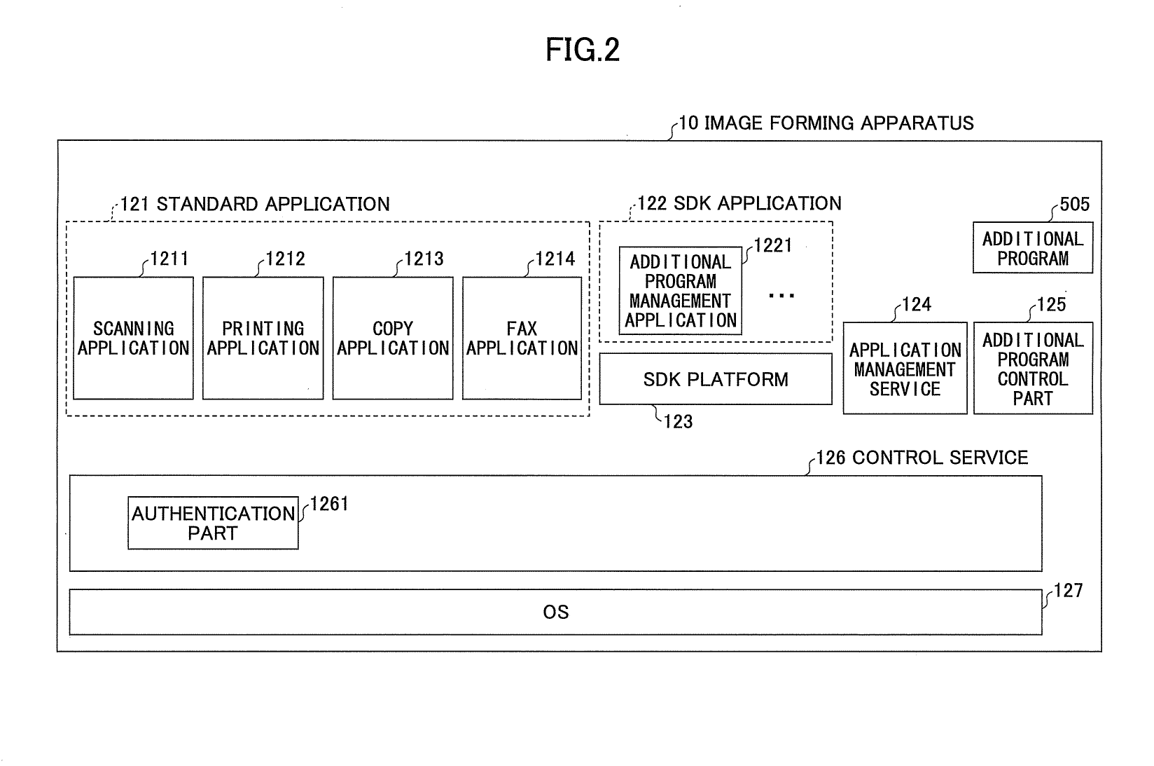

FIG. 2 is a block diagram illustrating a software configuration of the image forming apparatus 10 according to the embodiment of the present invention.

Referring to FIG. 2, the image forming apparatus 10 includes a standard application 121, a software development kit (SDK) application 122, an SDK platform 123, an application management service 124, an additional program control part 125, a control service 126, and an operating system (OS) 127.

The OS 127 is a so-called operating system. Individual software items in the image forming apparatus 10 operate as processes or threads on the OS 127.

The control service 126 is a group of service-providing software modules shared by a group of superordinate software modules. In FIG. 2, an authentication part 1261 is illustrated as part of the control service 126. The authentication part 1261 provides services such as execution of an authentication process in response to the entry of a username and a password. In addition, the control service 126 includes software modules providing services related to network communications, services related to scanner control, services related to printer control, and services related to memory management.

The standard application 121 is a set of applications that are normally stored (that is, stored in advance at the time of shipment) in the image forming apparatus 10. In FIG. 2, a scanning application 1211, a printing application 1212, a copy application 1213, and a FAX application 1214 are illustrated as example applications of the standard application 121. The scanning application 1211 executes a scan job. The printing application 1212 executes a print job. The copy application 1213 executes a copy job. The FAX application 1214 executes a FAX transmission job and/or a FAX reception job.

The SDK application 122 may be installed and uninstalled at any time as a plug-in for adding functionality to the image forming apparatus 10 after the shipment of the image forming apparatus 10. FIG. 2 illustrates an additional program management application 1221 as an example of the SDK application 122. The additional program management application 1221 provides a user with an interface for causing an additional program to be operated.

The SDK platform 123 provides the execution environment of the SDK application 122. The SDK application 122 is developed using an application program interface (API) (hereinafter referred to as “SDK API”) provided by the SDK platform 123. For example, the SDK platform 123 provides the SDK application 122 with an SDK API for causing a scanning function to be used, an SDK API for causing a printing function to be used, or an SDK API for causing a copy function to be used. The SDK platform 123 uses a function provided by the control service 126 in response to a call performed by the SDK API, thereby implementing a service corresponding to the SDK API. That is, the SDK platform 123 conceals the interface of the control service 126, and provides the developer of the SDK application 122 with an API that is easier to understand. The SDK API has been made open to the public, and the SDK application 122 may be developed by a third-party vendor.

The application management service 124 manages the SDK application 122. For example, the application management service 124 installs or uninstalls the SDK application 122. Further, using the HDD 114 (FIG. 1), the application management service 124 manages a list (list information) of installed individual SDK applications of the SDK application 122.

The additional program control part 125 controls the operation of an additional program 505 in accordance with an instruction from the additional program management application 1221.

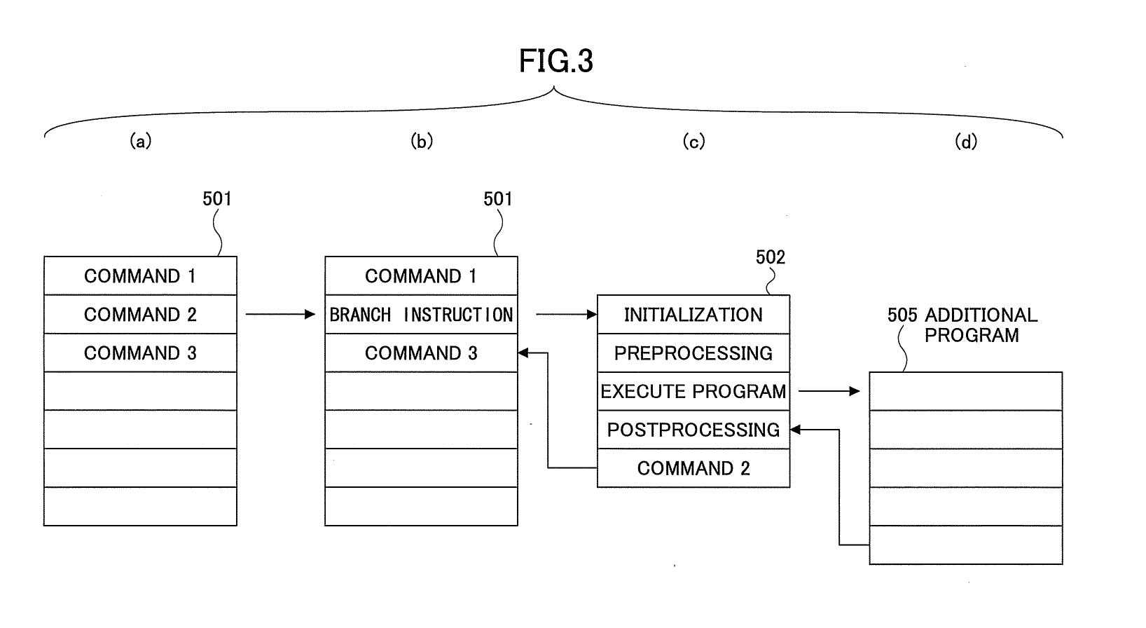

A description is given of the additional program 505. FIG. 3 is a diagram for illustrating the additional program 505.

In FIG. 3, (a) illustrates an array of commands on a virtual memory in a program 501 to which the additional program 505 ((d) of FIG. 3) is to be applied. Before application of the additional program 505 (at a normal execution time), the program 501 executes a process in order of COMMAND 1 to COMMAND 2 to COMMAND 3 (normal execution order).

In FIG. 3, (b) illustrates a state where the additional program 505 has been applied to the program 501 (at the time of executing the additional program 505). Here, (b) illustrates the case of inserting the process of the additional program 505 between COMMAND 1 and COMMAND 2. In this case, COMMAND 2 is replaced with a branch instruction to transfer control to a table 502. As illustrated in (c) of FIG. 3, a process is defined in the table 502 where COMMAND 2 is executed after initialization, preprocessing (such as saving variables in a stack), calling the additional program 505, and postprocessing (such as extracting the variables saved in the stack), and the process returns to COMMAND 3 of the program 501.

That is, in the case of application of the additional program 505, the process of the additional program 505 is executed when the execution steps of the program 501, which is a target of application of the additional program 505, reach a pre-specified point (position of addition). When the process of the additional program 505 ends, the process control returns to the program 501. Thereafter, the program 501 resumes its process at the position of addition. In addition to the process to be caused to interrupt the program 501, the additional program 505 includes information for identifying the program 501 (a target of application of the additional program 505) and the position of addition.

In the additional program 505, it is possible to refer to variables or the like of the program 501. Accordingly, with the additional program 505, it is possible to have the program 501 interrupted by one or more processes such as a process for causing log information to be output, the log information indicating the values of variables at any point in the program 501, a process for correcting bugs, and a process for implementing a new function.

According to such an additional program, with respect to a program that is a target of application of the additional program (a target application), it is possible to dynamically (that is, without correcting the source code, performing compiling and linking, or reinstalling the program) output log information, correct bugs, and/or enhance functions.

In this embodiment, applying an additional program to a target application and making the additional program executable, that is, loading an additional program into a memory and inserting a branch instruction of the loaded additional program into the target application, may be referred to as the “enablement” of the additional program. That is, mere storage in the image forming apparatus 10 does not cause the additional program to function, and the enablement of the additional program makes it possible for the additional program to cause a process to interrupt the target program.

A description is given of the additional program management application 1221.

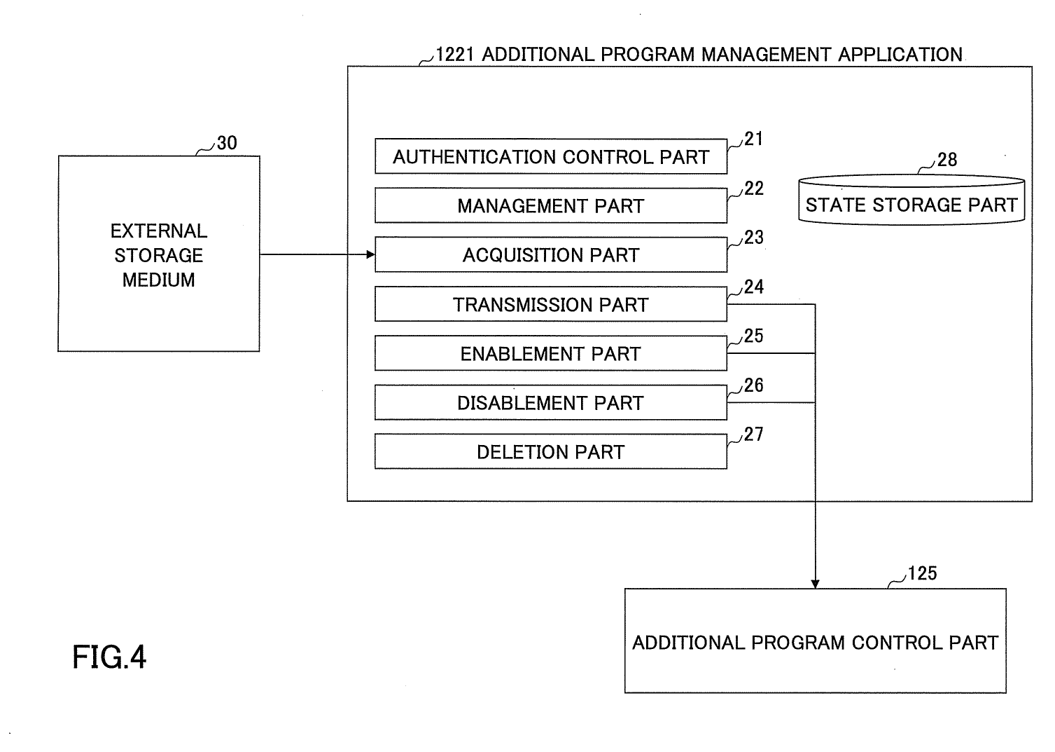

FIG. 4 is a block diagram illustrating a functional configuration of the additional program management application 1221.

Referring to FIG. 4, the additional program management application 1221 includes an authentication control part 21, a management part 22, an acquisition part 23, a transmission part 24, an enablement part 25, a disablement part 26, a deletion part 27, and a state storage part 28.

The authentication control part 21 controls a process for determining whether an operator is an authorized user of the additional program management application 1221. If the authentication control part 21 determines that the operator is an authorized user, the operator is allowed to use the additional program management application 1221. The management part 22 causes a screen for receiving operation instructions regarding the additional program 505 to be displayed on the operations panel 15 (FIG. 1), and causes a process according to the operation instructions input through the screen to be activated.

The acquisition part 23 acquires (downloads) the additional program 505 from an external storage medium 30. The external storage medium 30 may be a portable storage medium set in the image forming apparatus 10, such as the SD card 80 (FIG. 1) or a USB memory, or a computer such as a personal computer (PC) connected to the image forming apparatus 10 via a network. In any form of the external storage medium 30, the additional program 505 is stored in correlation with its corresponding identifier (additional program ID). The additional program 505 acquired by the acquisition part 23 is stored in the HDD 114 (FIG. 1) in correlation with its additional program ID.

The transmission part 24 transmits the additional program 505 acquired by the acquisition part 23 (and stored in the HDD 114) to the additional program control part 125. The enablement part 25 instructs the additional program control part 125 to enable the additional program 505 in accordance with instructions input by the user. The disablement part 26 instructs the additional program control part 125 to disable the additional program 505 in accordance with instructions input by the user. The “disablement” refers to the cancellation of application of the additional program 505. The deletion part 27 deletes the additional program 505 stored in the HDD 114 in accordance with instructions input by the user. The state storage part 28 is a storage area (such as a file or a database) where information indicating the state of the additional program 505 (the state information of the additional program 505) is stored in the HDD 114.

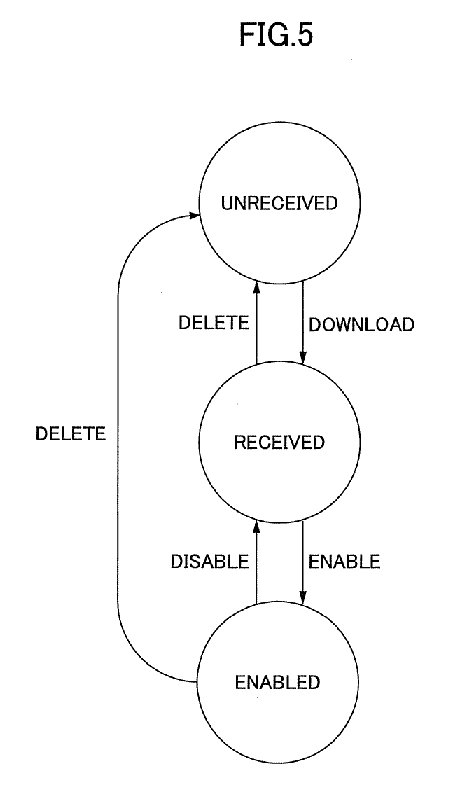

FIG. 5 is a diagram for illustrating the state transition of the additional program 505 in the image forming apparatus 10. According to this embodiment, the state transition of the additional program 505 may occur as illustrated in FIG. 5.

As illustrated in FIG. 5, the state of the additional program 505 in the image forming apparatus 10 is one of UNRECEIVED, RECEIVED, and ENABLED.

Of the states, UNRECEIVED is where the additional program 505 has not been received (downloaded) from the external storage medium 30 (that is, the additional program 505 is not present in the image forming apparatus 10). Once the additional program 505 is downloaded into the image forming apparatus 10, the state of the additional program 505 makes transition (changes) to RECEIVED. The additional program 505 in the RECEIVED state is merely stored in the HDD 114, and is not applied to a target program (to which the additional program 505 is to be applied). Accordingly, the additional program 505 in the RECEIVED state is not executed. When an instruction is given to enable the additional program 505 in the RECEIVED state, the state of the additional program 505 makes transition to ENABLED. The additional program 505 in the ENABLED state causes a process to interrupt the target application when the execution steps of the target application reach a position of addition (where the process of the additional program 505 is to be added).

If an instruction is given to disable the additional program 505 in the ENABLED state, the state of the additional program 505 returns to RECEIVED. If the additional program 505 is deleted in the ENABLED state or the RECEIVED state, the state of the additional program 505 returns to UNRECEIVED. In the case of deletion in the ENABLED state, the additional program 505 is disabled before its deletion.

Each state transition occurs in response to an operation instruction input by a user. In other words, each arrow in FIG. 5 corresponds to an operation instruction that may be input by a user with respect to the additional program 505.

A description is given below of a procedure of the image forming apparatus 10.

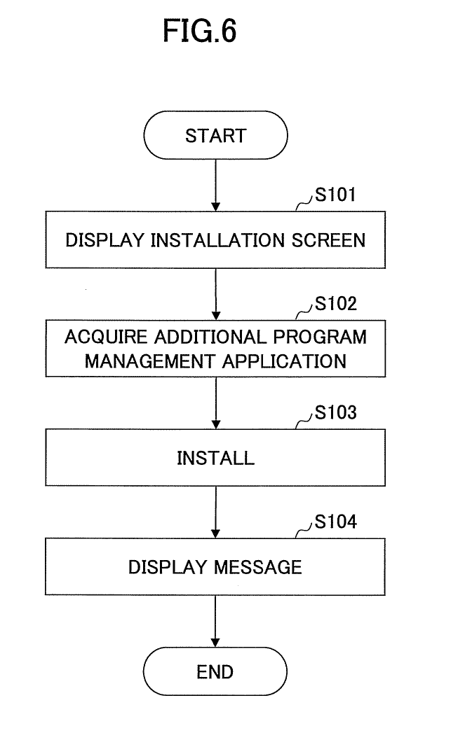

FIG. 6 is a flowchart for illustrating an installation process of the additional program management application 1221 (FIG. 2 and FIG. 4). That is, at the start of the flowchart of FIG. 6, the additional program management application 1221 is not installed in the image forming apparatus 10.

Referring to FIG. 6 as well as FIG. 1 and FIG. 2, in step S101, the application management service 124 causes an installation screen to be displayed on the operations panel 15. On the installation screen, a location is specified where the SDK application (here, the additional program management application 1221) to be installed is stored. The location is, for example, the SD card 80 set in the image forming apparatus 10 or a computer connected to the image forming apparatus 10 via a network.

In step S102, in response to the specification of the storage location of the installation target, the application management service 124 acquires the archive file of the additional program management application 1221 stored in the storage location. Then, in step S103, the application management service 124 decompresses the archive file, and installs the executable file of the additional program management application 1221 stored in the archive file. As part of the installation process, the application management service 124 stores an application information file stored in the archive file at a predetermined storage position in the HDD 114. The application information file is written in a format common to the individual SDK applications 122.

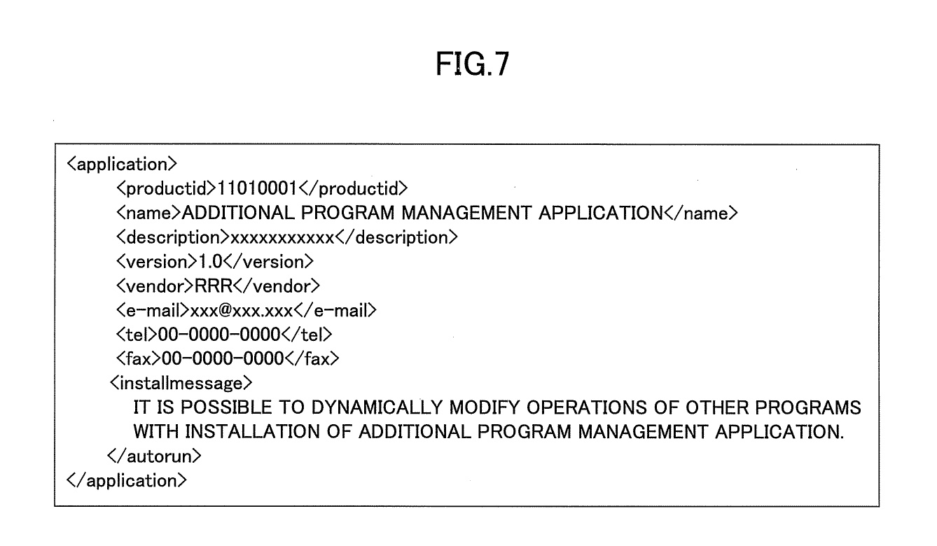

FIG. 7 is a diagram illustrating an application information file. The application information file of FIG. 7 is described in an XML (eXtensible Markup Language) format having the “application” element between <application> tags as a root element.

The elements of the “application” element correspond to the attribute items of the SDK application 122. That is, the value of the “productid” element indicates the value of the product ID of the additional program management application 1221. The product ID is unique to the SDK application 122 on a product basis (a type basis). The value of the “name” element indicates an application name. The value of the “description” element indicates a description of the SDK application 122. The value of the “version” element indicates the version of the SDK application 122. The value of the “vendor” element indicates the developer and vendor of the SDK application 122. The values of the “e-mail” element, the “tel” element, and the “fax” element indicate the e-mail address, the telephone number, and the facsimile number, respectively, of the developer and vendor. The value of the “installmessage” element is a message to be displayed in the case of a success in installation.

In response to the installation of the SDK application 122, the application information file is stored at a predetermined storage position in the HDD 114. This makes it possible to have list information of the individual SDK applications 122 installed in the image forming apparatus 10.

Referring back to FIG. 6, once the installation is completed, in step S104, the application management service 124 causes the value of the “installmessage” element of the application information file to be displayed on the operations panel 15. Here, a message such as “IT IS POSSIBLE TO DYNAMICALLY MODIFY OPERATIONS OF OTHER PROGRAMS WITH INSTALLATION OF ADDITIONAL PROGRAM MANAGEMENT APPLICATION” is displayed. With this message, it is possible to call a user's attention to the security of the programs of the image forming apparatus 10. This is because while the additional program 505 has the convenience of making it possible to dynamically modify the behavior of a target program, such convenience may be accompanied by the side effect of degraded security.

The function of the additional program control part 125 is substantially enabled by the installation of the additional program management application 1221. This is because the additional program control part 125 is caused to function by being used by the additional program management application 1221.

Next, a description is given of a process of the image forming apparatus 10 after the installation of the additional program management application 1221.

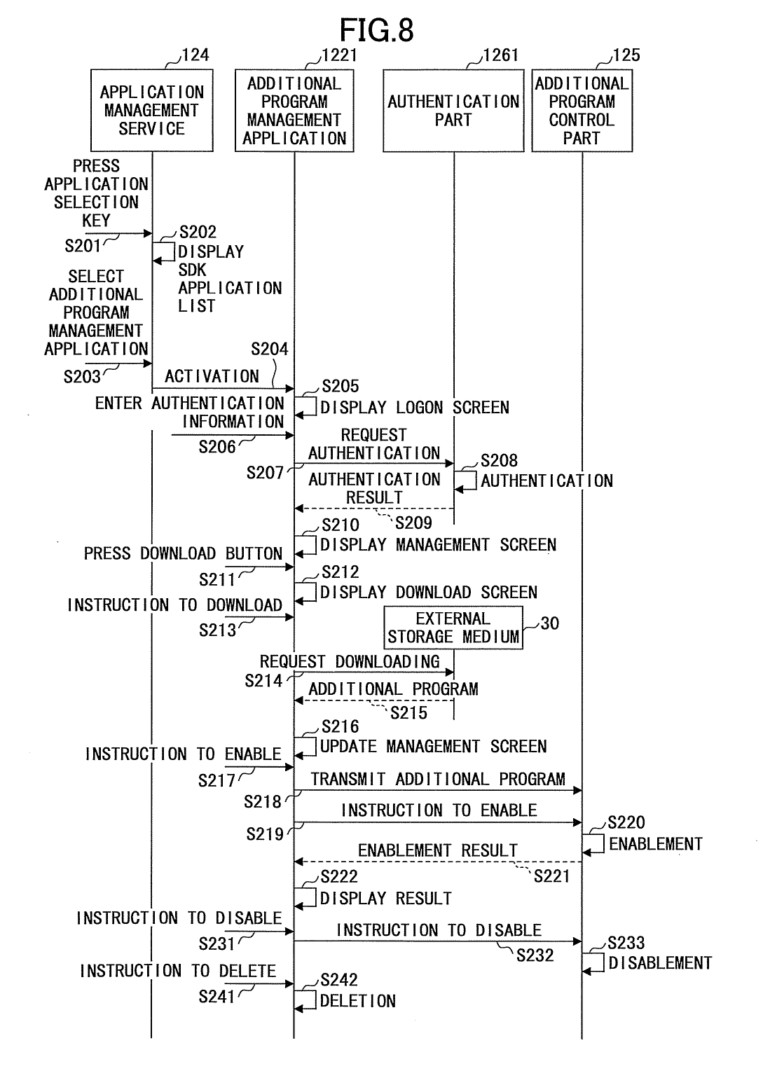

FIG. 8 is a sequence diagram for illustrating a procedure of the image forming apparatus 10 that the additional program management application 1221 causes to be executed.

Referring to FIG. 8 as well as FIG. 2 and FIG. 4, in step S201, in response to an operator pressing a predetermined hard key on the operations panel 15, the application management service 124 is notified of the pressing event of the hard key. On the operations panel 15, a hard key (a key for selecting an application) is provided for each individual standard application 121. This is because the presence of the standard application 121, which is incorporated in the image forming apparatus 10, is static. On the other hand, the presence of the SDK application 122 is fluid (dynamic). Accordingly, a single hard key (an SDK application selection key) is assigned to a set of individual SDK applications 122. In step S201, the SDK application selection key is pressed.

In step S202, in response to the pressing of the SDK application selection key, the application management service 124 causes an SDK application list screen to be displayed on the operations panel 15. On the SDK application list screen, activation buttons are displayed one for each corresponding SDK application 122 installed in the image forming apparatus 10. Therefore, according to this embodiment, the activation button of the additional program management application 1221 is displayed. The application management service 124 causes the SDK application list screen to be displayed based on the group of application information files recorded in the HDD 114.

In step S203, the activation button of the additional program management application 1221 is selected on the SDK application list screen. Then, in step S204, the application management service 124 causes the additional program management application 1221 to be activated as an operation target. In step S205, in response to the activation, the authentication control part 21 of the additional program management application 1221 causes a logon screen to be displayed on the operations panel 15.

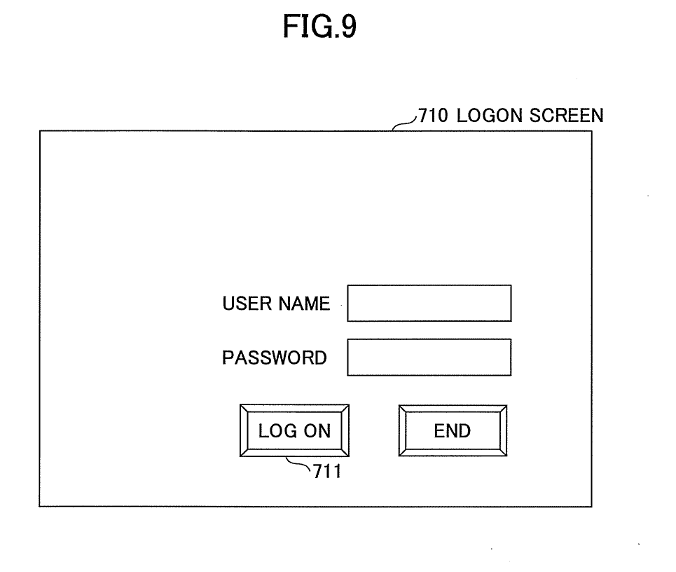

FIG. 9 is a diagram illustrating an example of the display of the logon screen. As illustrated in FIG. 9, a logon screen 710 includes entry fields for a username and a password.

In step S206, authentication information including a username and a password are entered on the logon screen 710, and a logon button 711 is pressed. Then, in step S207, the authentication control 21 inputs the username and the password to the authentication part 1261, and requests the authentication part 1261 to execute authentication (an authentication process). In step S208, the authentication part 1261 executes authentication by collating the input username and password with the usernames and passwords included in the user information pre-recorded in the HDD 114, and in step S209, the authentication part 1261 outputs the result of the authentication to the authentication control part 21.

If the result of the authentication output by the authentication part 1261 indicates a success of the authentication, in step S210, the management part 22 of the additional program management application 1221 causes a management screen to be displayed on the operations panel 15.

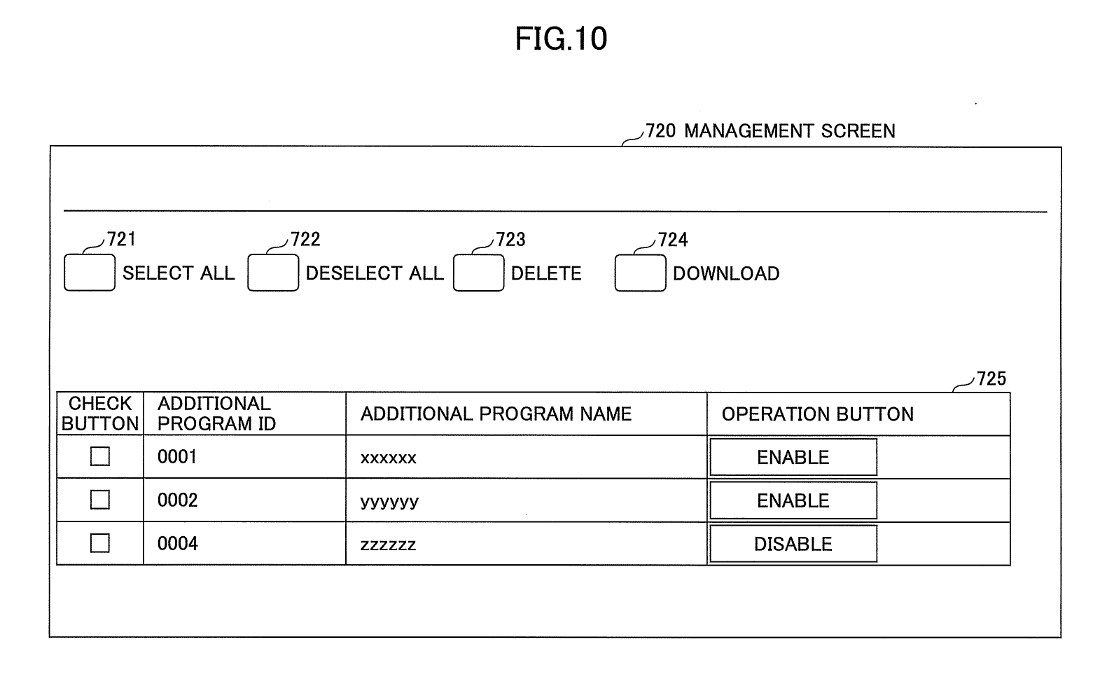

FIG. 10 is a diagram illustrating an example of the display of the management screen. In FIG. 10, a management screen 720 includes a SELECT ALL button 721, a DESELECT ALL button 722, a DELETE button 723, a DOWNLOAD button 724, and an additional program list table 725.

In the additional program list table 725, a check button, an additional program ID, an additional program name, and an operation button are displayed for each of the additional programs 505 that have been downloaded into the image forming apparatus 10. The check button is for causing the additional program 505 to be operated to be selected. The operation button is for receiving the input of an instruction to enable or disable the additional program 505. A character string “DISABLE” is displayed in the label of the operation button for the enabled additional program 505. A character string “ENABLE” is displayed in the label of the operation button for the received additional program 505 (that is, the additional program 505, that has not been enabled). That is, the process executed in response to the pressing of the operation button differs depending on the state of the additional program 505 corresponding to the operation button. The management part 22 causes the contents of the additional program list table 725 to be displayed based on the information recorded in the state storage part 28.

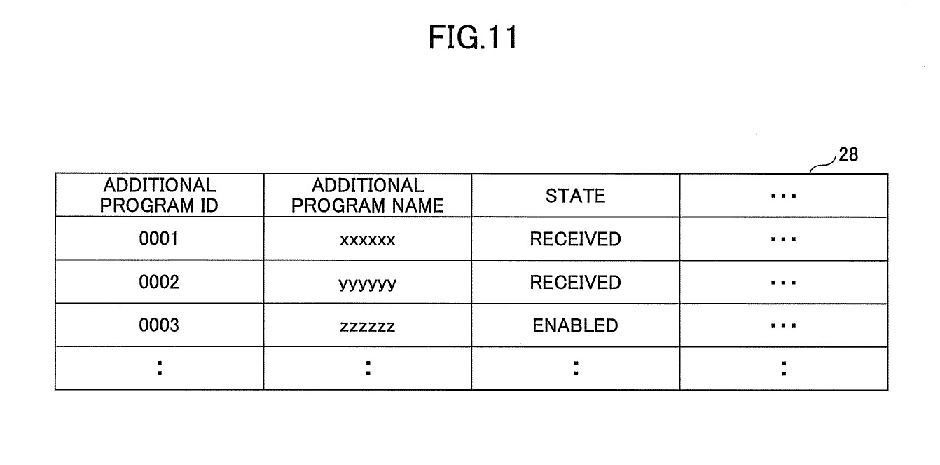

FIG. 11 is a diagram illustrating configuration of the state storage part 28.

In FIG. 11, the state storage part 28 contains an additional program ID, an additional program name, and a state on an additional program basis.

Referring back to FIG. 10, the SELECT ALL button 721 is for causing all the check buttons included in the additional program list table 725 to be selected. The DESELECT ALL button 722 is for canceling the selected states of all the check buttons included in the additional program list table 725. The DELETE button 723 is for receiving an instruction to delete the additional program 505 whose check button is selected in the additional program list table 725. The DOWNLOAD button 724 is for receiving an instruction to download the additional program 505 from the external storage medium 30.

Referring back to FIG. 8, in step S211, the DOWNLOAD button 724 is pressed on the management screen 720. In response, in step S212, the acquisition part 23 of the additional program management application 1221 causes a download screen to be displayed on the operations panel 15.

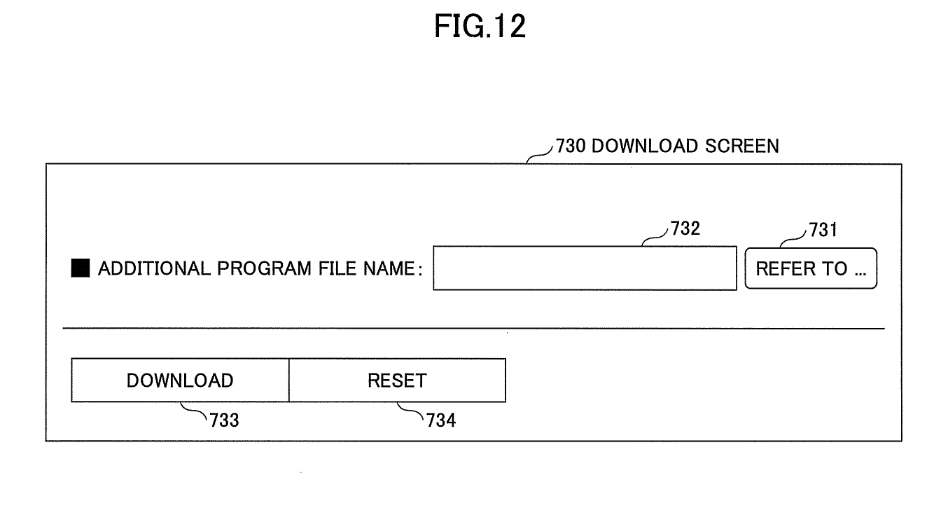

FIG. 12 is a diagram illustrating an example of the display of the download screen.

In FIG. 12, a download screen 730 includes a REFER TO button 731, a text box 732, a DOWNLOAD button 733, and a RESET button 734.

In response to the pressing of the REFER TO button 731, the acquisition part 23 causes a file dialog to be displayed on the operations screen 15. The file dialog is for causing a list of the files of the additional programs 505 stored in the external storage medium 30 to be displayed. In response to selection of a desired additional program 505 in the file dialog, the acquisition part 23 recognizes the selected additional program 505 as a target of downloading, and causes the file name of the additional program 505 to be displayed in the text box 732 after hiding the file dialog. In response to the pressing of the RESET button 734, the acquisition part 23 clears the text box 732 (that is, the acquisition part 23 deletes the file name of the additional program 505 to be downloaded).

In step S213, the DOWNLOAD button 733 is pressed on the download screen 730. In response, in step S214, the acquisition part 23 makes a downloading request to the external storage medium 30, and in step S215, the acquisition part 23 downloads the additional program 505 whose file name is displayed in the text box 732 from the external storage medium 30 and stores the downloaded additional program 505 in the HDD 114. In response to the downloading, the acquisition part 23 adds a record related to the downloaded additional program 505 to the state storage part 28. At this point, RECEIVED is recorded in the STATE field of the record.

In response to the completion of the downloading, in step S216, the management part 22 causes the management screen 720 (FIG. 10) to be displayed again on the operations screen 15. The display contents of the management screen 720 at this point, which are based on the updated state storage part 28, are different from the display contents in step S210. That is, a row related to the newly downloaded additional program 505 is added to the additional program list table 725.

Next, in step S217, an operation button whose label is “ENABLE” in the additional program list table 725 is pressed on the management screen 720. In response, in step S218, the transmission part 24 obtains the additional program 505 corresponding to the pressed operation button from the HDD 114, and transmits the obtained additional program 505 to the additional program control part 125. The additional program control part 125 loads the received additional program 505 into a memory so that the received additional program 505 may be executed.

Next, in step S219, the enablement part 25 of the additional program management application 1221 specifies the additional program ID of the additional program 505 transmitted by the transmission part 24, and transmits an instruction to enable the additional program 505 to the additional program control part 125. In response to the instruction to enable the additional program 505, in step S220, the additional program control part 125 enables the additional program 505 corresponding to the specified additional program ID. That is, a branch instruction to transfer control to the additional program 505 is inserted in a target program (such as the standard application 121 or the SDK application 122). Accordingly, in the process to follow, the additional program 505 is executed when the execution steps of the target program reach a position where the additional program 505 is to be added. As a result, a function (of, for example, outputting logs, correcting bugs, or expanding functionality) incorporated in the additional program 505 is added to the target program.

Next, in step S221, the additional program control part 125 returns the execution result (success or failure) of the enablement to the enablement part 25. In step S222, the enablement part 25 causes a message indicating the execution result to be displayed on the operations panel 15. In the case of a success in the enablement, the enablement part 25 updates the value of the state stored in the state storage part 28 to ENABLED with respect to the enabled additional program 505.

On the other hand, in step S231, an operation button whose label is DISABLE in the additional program list table 725 is pressed on the management screen 720. In response, in step S232, the disablement part 26 specifies the additional program ID of an additional program 505 corresponding to the pressed operation button, and transmits an instruction to disable the additional program 505 to the additional program control part 125. In response to the instruction to disable the additional program 505, in step S233, the additional program control part 125 disables the additional program 505 corresponding to the specified additional program ID. That is, the application of the additional program 505 to the target application is canceled. That is, the branch instruction to transfer control to the additional program 505 is removed from the target application. As a result, the behavior of the target program returns to its original behavior. In the case of a success in the disablement, the disablement part 26 updates the value of the state stored in the state storage part 28 to RECEIVED with respect to the disabled additional program 505.

Further, in step S241, the DELETE button 723 is pressed on the management screen 720. In response, in step S242, the deletion part 27 of the additional program management application 1221 deletes an additional program 505 whose check button is selected in the additional program list table 725 from the HDD 114. In the case of a success in the deletion, the deletion part 27 updates the value of the state stored in the state storage part 28 to UNRECEIVED with respect to the deleted additional program 505.

As described above, the image forming apparatus 10 of this embodiment contains the additional program management application 1221 that implements the function of the management server described in Japanese Laid-Open Patent Application No. 2009-146387, etc. Accordingly, it is possible to cause the single image forming apparatus 10 to independently perform operations related to the additional program 505. This eliminates the necessity of installing a management server, thus making it possible to use the additional program 505 with a simpler system configuration.

Further, by implementing the additional program management application 1221 as one of the individual SDK applications 122, it is possible to have functions of the image forming apparatus 10, such as an authentication function, shared with the additional program management application 1221 as they are. As a result, it is possible to restrict access to the additional program management application 1221 in accordance with the access control function of the image forming apparatus 10.

Further, as a result of simplification of the system configuration, it is possible to increase the independence of the image forming apparatus 10 with respect to the operation of the additional program 505. For example, in the case of installing a single management server for multiple image forming apparatuses 10, occurrence of a failure in the management server makes it impossible to operate the additional program 505 for all the image forming apparatuses 10. On the other hand, causing the additional program 505 to be operated on an image forming apparatus 10 basis as in this embodiment makes it possible to avoid occurrence of such inconvenience.

Further, the additional program management application 1221 may be installed or uninstalled as desired by a user. Accordingly, it is possible to have users determine whether to introduce an environment where the additional program 505 is applicable on an image forming apparatus 10 basis based on the comparison and consideration of the convenience and inconvenience due to installation of the additional program management application 1221. The convenience due to installation of the additional program management application 1221 is the capability of dynamically altering the behavior of a program incorporated or installed in the image forming apparatus 10. The inconvenience due to installation of the additional program management application 1221 is the likelihood of exclusion from objects of security-related authentication such as P2600 due to the capability of dynamically altering the behavior of a program incorporated or installed in the image forming apparatus 10.

Screens of the additional program management application 1221 may be distributable on the network as Web pages (HTML [HyperText Markup Language] data). This makes it possible to cause the additional program management application 1221 to be operated from not only the operations panel 15 but also a Web browser of a PC connected to the image forming apparatus 10 via the network.

Further, according to this embodiment, the image forming apparatus 10 is taken as an example of electronic apparatuses. However, electronic apparatuses to which the present invention may be applied are not limited to image forming apparatuses. For example, the present invention is also effectively applicable to digital home appliances, portable devices, and general-purpose computers.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

The present application is based upon and claims the benefit of priority of Japanese Patent Application No. 2009-238978, filed on Oct. 16, 2009, the entire contents of which are incorporated herein by reference.

What is claimed is:

1. An image forming apparatus, comprising:
an acquisition part configured to cause a first screen for selecting a first program to be displayed on a display part, and to acquire the first program selected on the first screen from an external storage part, the first program being capable of having a process thereof dynamically interrupt a second program of the image forming apparatus; and
an enablement part configured to apply the obtained first program to the second program.

2. The image forming apparatus as claimed in claim 1, further comprising:
a management part configured to cause a second screen to be displayed on the display part, the second screen including a list of programs acquired from the external storage part, the acquired programs including the first program,
wherein the enablement part is configured to apply the first program selected from the list to the second program by the enablement part.

3. The image forming apparatus as claimed in claim 2, wherein:
the enablement part is configured to record, in a storage part, state information indicating a presence or an absence of an application to the second program with respect to the acquired programs,
the management part is configured to cause a display component to be displayed on the second screen based on the state information, the display component being configured to cause one of a first instruction to cause said application to the second program and a second instruction to cancel said application to the second program to be generated with respect to the acquired programs in the list on a program-by-program basis.

4. The image forming apparatus as claimed in claim 3, further comprising:
a disablement part configured to cancel said application to the second program with respect to one of the acquired programs with respect to which the second instruction to cancel said application to the second program is generated via the display component.

5. A program operating method executed by an image forming apparatus, comprising:
causing a first screen for selecting a first program to be displayed on a display part, the first program being capable of having a process thereof dynamically interrupt a second program of the image forming apparatus;
acquiring the first program selected on the first screen from an external storage part; and
applying the obtained first program to the second program.

6. The program operating method as claimed in claim 5, further comprising:
causing a second screen to be displayed on the display part, the second screen including a list of programs acquired from the external storage part, the acquired programs including the first program,
wherein said applying applies the first program selected from the list to the second program.

7. The program operating method as claimed in claim 6, further comprising:
recording, in a storage part, state information indicating a presence or an absence of an application to the second program with respect to the acquired programs; and
causing a display component to be displayed on the second screen based on the state information, the display component being configured to cause one of a first instruction to cause said application to the second program and a second instruction to cancel said application to the second program to be generated with respect to the acquired programs in the list on a program-by-program basis.

8. The program operating method as claimed in claim 7, further comprising:
canceling said application to the second program with respect to one of the acquired programs with respect to which the second instruction to cancel said application to the second program is generated via the display component.
